(19) United States
(12) Patent Application Publication
(10) Pub. No.: US 2026/0106164 A1
(43) Pub. Date: Apr. 16, 2026

(54) CURRENT COLLECTOR AND POWER STORAGE DEVICE

(71) Applicant: Industrial Technology Research Institute, Hsinchu (TW)

(72) Inventors: Yu-Kai Liao, Hsinchu County (TW); Chia-Erh Liu, Hsinchu County (TW); Shih-Chieh Liao, Taoyuan City (TW); Jin-Ming Chen, Taoyuan City (TW); Shian-Ching Jang, Hsinchu County (TW); Po-Sung Chen, Tainan City (TW)

(73) Assignee: Industrial Technology Research Institute, Hsinchu (TW)

(21) Appl. No.: 19/359,696

(22) Filed: Oct. 16, 2025

Related U.S. Application Data
(60) Provisional application No. 63/708,247, filed on Oct. 16, 2024.

(30) Foreign Application Priority Data
Jul. 31, 2025 (TW) 114129053

(51) Int. Cl. H01M 4/66; H01M 4/62

(52) U.S. Cl. CPC H01M 4/662; H01M 4/628; H01M 4/667

(57) ABSTRACT

A current collector and a power storage device are provided. The current collector includes a substrate and an alloy layer. The alloy layer is located on one side of the substrate. A material of the alloy layer is an alloy material. The alloy material includes aluminum, silicon and at least three other elements. Based on a sum of the elements of the alloy material is 100 mole percentage, a sum of the elements of aluminum and silicon is greater than or equal to 70 mole percentage.

### CROSS-REFERENCE TO RELATED APPLICATION

This application claims the priority benefit of U.S. provisional application Ser. No. 63/708,247, filed on Oct. 16, 2024 and Taiwan application serial no. 114129053, filed on Jul. 31, 2025. The entirety of each of the above-mentioned patent applications is hereby incorporated by reference herein and made a part of specification.

### TECHNICAL FIELD

The technical field relates to a current collector and a power storage device.

### BACKGROUND

In power storage devices, next-generation lithium-ion secondary batteries have attracted attention due to their characteristics of being repeatedly chargeable and dischargeable and having high energy density. However, existing lithium batteries easily form lithium dendrite at the anode when the full battery is charged, causing problems such as poor cycle life time or short circuits in the lithium batteries, thereby affecting the stability and performance of the lithium batteries.

### SUMMARY

One of exemplary embodiments comprises a current collector including a substrate and an alloy layer. The alloy layer is located on one side of the substrate. A material of the alloy layer is an alloy material. The alloy material includes aluminum, silicon and at least three other elements. Based on a sum of elements of the alloy material is 100 mole percentage, a sum of elements of aluminum and silicon is greater than or equal to 70 mole percentage.

One of exemplary embodiments comprises a power storage device including the aforementioned current collector.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic diagram of a current collector according to an exemplary embodiment.

FIG. 2 is a schematic diagram of a power storage device according to an exemplary embodiment.

FIG. 3A is a curve diagram of potential varying with time measured by configuring the current collectors of Example 1, Example 4, and Comparative Example 1 according to exemplary embodiments respectively into half-cell structures (wherein the measurement conditions are 0.5 mA cm⁻² and 1 mAh cm⁻²).

FIG. 3B is a curve diagram of potential varying with time during charging and discharging by configuring the current collectors of Example 1, Example 4, and Comparative Example 1 according to exemplary embodiments respectively into half-cell structures (wherein the measurement conditions are 0.5 mA cm⁻² and 1 mAh cm⁻²).

FIG. 4 is a curve diagram of discharge capacity varying with cycle number during cyclic charging and discharging of anode-free lithium batteries of Examples 1 to 4 and Comparative Example 1 according to exemplary embodiments (wherein the charging rate is 0.2C and the discharging rate is 1C).

### DETAILED DESCRIPTION OF DISCLOSURED EMBODIMENTS

The following will comprehensively describe exemplary implementations of the disclosure with reference to the figures, but the disclosure may also be implemented in many different forms and should not be construed as limited to the implementations described herein. In the figures, the sizes and thicknesses of components, parts, and layers may not be drawn to actual scale for clarity. Directional terms mentioned in this document, such as “upper”, “lower”, “front”, “back”, etc., are only referenced to the orientation of the accompanying figures. Therefore, the directional terms used are for explaining and understanding this application, and not for limiting this application. Additionally, in the specification, unless explicitly described otherwise, the word “include” will be understood to mean including the stated elements, but not excluding any other elements. For ease of understanding, the same elements in the following description will be explained using the same symbols.

The implementation details provided in the implementations are for illustrative purposes and are not intended to limit the scope of protection of the disclosure. Any expert in the relevant technical field may modify or vary these implementation details according to the needs of actual implementation. Moreover, descriptions of well-known devices, methods, and materials may be omitted to avoid obscuring the description of the various principles of the disclosure.

Ranges in this document may be expressed from “about” one specific value to “about” another specific value, or may be directly expressed as one specific value and/or to another specific value. When expressing said range, another implementation includes from that one specific value and/or to another specific value. Similarly, when values are expressed as approximations by using the antecedent “about”, it will be understood that the specific value forms another implementation. It will be further understood that the endpoints of each range are apparently related or unrelated to another endpoint.

In this document, non-limiting terms (such as: may, can, for example, or other similar expressions) are for non-essential or optional implementation, inclusion, addition, or presence.

Unless otherwise defined, all terms used herein (including technical and scientific terms) have the same meanings as commonly understood by experts in the technical field to which the disclosure pertains. It will also be understood that terms, such as those defined in commonly used dictionaries, should be interpreted as having meanings consistent with their meaning in the context of the relevant art and should not be interpreted in an idealized or overly formal sense unless explicitly so defined herein.

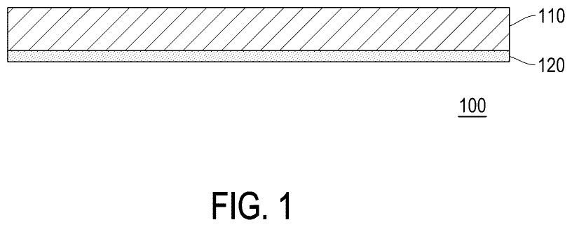

FIG. 1 is a schematic diagram of a current collector according to an exemplary embodiment. Please refer to FIG. 1, a current collector 100 includes a substrate 110 and an alloy layer 120 located on one side of the substrate 110. The alloy layer 120 may be direct contact or indirect contact with one side of the substrate 110. In the case of indirect contact, there may be other suitable components between the alloy layer 120 and the substrate 110. In this embodiment, the alloy layer 120 is direct contact with one side of the substrate 110. The alloy layer 120 is located on one side of the substrate 110 and is direct contact with the side of the substrate 110. The alloy layer 120 is direct contact with a surface of the substrate 110. The alloy layer 120 is located on one surface of the substrate 110 and is direct contact with the surface of the substrate 110.

A material of the substrate 110 may include copper, iron, tin, silicon, or a combination thereof. In some embodiments, the substrate is a copper substrate. For example, the copper substrate may include copper foil, copper foam, copper mesh, or other suitable copper substrates. A thickness of the substrate 110 may be 4 micrometers to 50 micrometers, for example 6 micrometers to 12 micrometers.

A material of the alloy layer 120 is an alloy material. The alloy material includes aluminum (Al), silicon (Si), and at least three other elements. The other elements are not particularly limited, and suitable elements may be selected according to needs. For example, the other elements may be metallic elements. In this embodiment, the other elements may include vanadium (V), niobium (Nb), tungsten (W), copper (Cu), iron (Fe), cobalt (Co), nickel (Ni), or manganese (Mn). The alloy material may include aluminum, silicon, and at least three elements selected from vanadium, niobium, tungsten, copper, iron, cobalt, nickel, or manganese. In some embodiments, the at least three other elements included in the alloy material include copper, manganese, nickel, iron, or niobium.

Based on a sum of elements of the alloy material is 100 mole percentage, a sum of elements of aluminum and silicon is greater than or equal to 70 mole percentage, for example 70 mole percentage to 90 mole percentage; and the remainder contains at least three elements. In the alloy material, a mole percentage of aluminum may be greater than a mole percentage of silicon. A molar ratio of a content of aluminum to a content of silicon may be 3:2 to 3:1, for example 2:1 to 5:2. In this embodiment, based on the sum of elements of the alloy material is 100 mole percentage, the content of aluminum may be 40 mole percentage to 60 mole percentage, for example 50 mole percentage to 58 mole percentage; the content of silicon may be 20 mole percentage to 30 mole percentage, for example 25 mole percentage to 29 mole percentage; and the remainder contains at least three elements. Based on the sum of elements of the alloy material is 100 mole percentage, a sum of content of the at least three elements may be 10 mole percentage to 30 mole percentage, for example 13 mole percentage to 25 mole percentage.

A thickness of the alloy layer may be 10 nanometers to 500 nanometers, for example 50 nanometers to 250 nanometers.

A manufacturing method of the current collector is not particularly limited. For example, the manufacturing method of the current collector may include: providing a substrate; and applying the aforementioned alloy material to one side of the substrate to form an alloy layer.

A method of applying the alloy material to the substrate may use high-temperature sintering, coating, deposition, or other suitable methods. The coating method may include spray coating, roll coating, spin coating, or similar methods. The deposition method may include magnetron sputtering deposition, electrodeposition, chemical vapor deposition, atomic layer deposition, pulsed laser deposition, or similar methods. In this embodiment, the alloy material is used as a sputtering target material, and the magnetron sputtering deposition method is used to deposit the alloy material on the surface of the substrate to form an alloy layer modified substrate, thereby obtaining the current collector. The thickness of the alloy layer may be adjusted by controlling the deposition time.

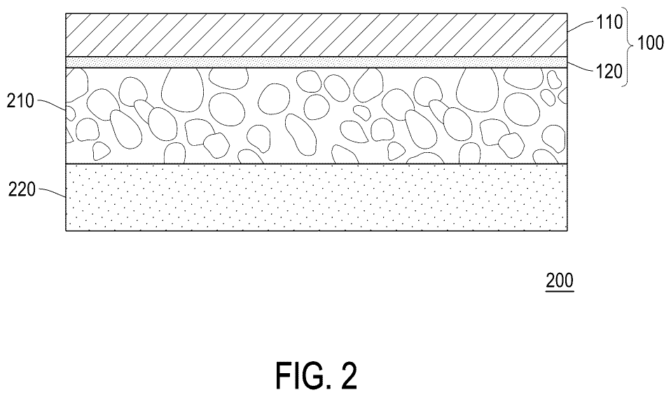

FIG. 2 is a schematic diagram of a power storage device according to an exemplary embodiment. Please refer to FIG. 2, a power storage device 200 includes the aforementioned current collector 100. The power storage device 200 may be a battery, a capacitor, or other suitable power storage devices. The battery may include a lithium battery, a solar cell, a lead-acid battery, or other suitable batteries. According to the difference of the power storage device, the power storage device 200 may further include other components known to those having ordinary knowledge in the art.

For example, when the power storage device 200 is a lithium battery, the power storage device 200 may further include a positive electrode 220, an electrolyte 210, a separator (not shown), and other components known to those having ordinary knowledge in the art, which will not be described in detail herein. The electrolyte 210 may be located between the positive electrode 220 and the alloy layer 120 of the current collector 100. The electrolyte 210 may include lithium salt, solvent, and other suitable additives.

For example, when the power storage device 200 is a capacitor, the power storage device 200 may further include a positive electrode 220, a dielectric 210, and other components known to those having ordinary knowledge in the art, which will not be described in detail herein. The dielectric 210 may be located between the positive electrode 220 and the alloy layer 120 of the current collector 100. The dielectric 210 is an insulator. The dielectric 210 may include aluminum oxide, ceramic, and other suitable dielectrics.

### EXAMPLES OF CURRENT COLLECTOR

### Preparation Example 1

High-purity Al, Si, Cu, Mn, and Ni elements were prepared according to a molar ratio of 54:27:13:3:3 to form a raw material of the target material. Next, the raw material was smelted into ingots using vacuum arc melting under an argon atmosphere, and each ingot was smelted at least 2 times to ensure compositional uniformity. Subsequently, the several smelted ingots were placed in an alumina crucible, and vacuum induction melting (VIM) was used to melt a material under an argon atmosphere, followed by tilt casting to form a plate. Next, the plate was cut into 3-inch diameter discs using a wire cutting machine, then a copper backing plate was attached to the back of the disc and finished to manufacture the target material.

### Preparation Example 2

High-purity Al, Si, Cu, Mn, and Ni elements were prepared according to a molar ratio of 56.7:28.3:10.2:2.4:2.4 to form a raw material of the target material. Next, the raw material was smelted into ingots using vacuum arc melting under an argon atmosphere, and each ingot was smelted at least 2 times to ensure compositional uniformity. Subsequently, the several smelted ingots were placed in an alumina crucible, and vacuum induction melting (VIM) was used to melt a material under an argon atmosphere, followed by tilt casting to form a plate. Next, the plate was cut into 3-inch diameter discs using a wire cutting machine, then a copper backing plate was attached to the back of the disc and finished to manufacture the target material.

### Example 1

A copper foil (thickness of 8 micrometers) was provided as the substrate, and Al₅₄Si₂₇Cu₁₃Mn₃Ni₃ obtained from Preparation Example 1 was provided as the sputtering target material. Argon gas was introduced at a flow rate of 10 sccm under high vacuum conditions. The process background pressure was controlled at 10 mtorr, the stage rotation rate was controlled at 8 rpm, the sputtering gun power was 2.2 W cm⁻², and the distance between the sputtering gun and the stage was 7 cm. The deposition process was performed for 5 minutes to form an alloy layer of Al₅₄Si₂₇Cu₁₃Mn₃Ni₃ (thickness of 180 nm) on the copper foil, thereby obtaining the current collector of Example 1. By observing the cross-section of the alloy layer using scanning electron microscope (SEM) and energy-dispersive X-ray spectroscopy (EDS or EDX), it can be confirmed that the alloy layer has uniform element distribution, uniform thickness, and uniform deposition surface coverage.

Next, lithium metal foil, separator, and electrolyte were provided. After assembling in the order of lithium metal foil/separator/aforementioned current collector, the electrolyte was injected to complete the assembly of the half cell.

### Example 2 to Example 3

The current collector of Example 2 to Example 3 were prepared using the same steps as Example 1, and the difference thereof was: the time of the deposition process for Example 2 and Example 3 were 3 minutes and 1 minute, respectively. That is, the thicknesses of the alloy layer of Example 2 and Example 3 were about 108 nm and about 36 nm, respectively.

### Example 4

The current collector of Example 4 was prepared using the same steps as Example 1, and the difference thereof was: Al_{56.7}Si_{28.3}Cu_{10.2}Mn_{2.4}Ni_{2.4} obtained from Preparation Example 2 was used as the sputtering target material, and argon gas was introduced at a flow rate of 10 sccm under high vacuum conditions. The process background pressure was controlled at 10 mtorr, the stage rotation rate was controlled at 8 rpm, the sputtering gun power was 2.2 W cm⁻², and the distance between the sputtering gun and the stage was 7 cm. The deposition process was performed for 5 minutes to form an alloy layer of Al_{56.7}Si_{28.3}Cu_{10.2}Mn_{2.4}Ni_{2.4} (thickness of 180 nm) on the copper foil, thereby obtaining the current collector of Example 4.

### Comparative Example 1

The current collector of Comparative Example 1 differs from that of Example 1 in that Comparative Example 1 did not deposit an alloy material on the copper substrate. That is, the current collector of Comparative Example 1 had only the copper substrate.

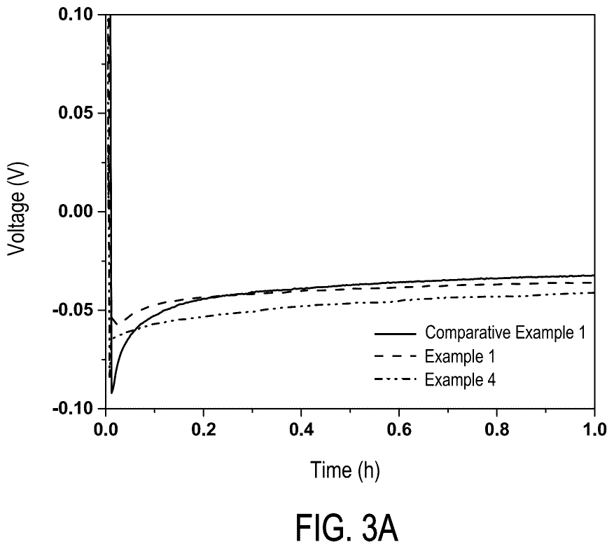

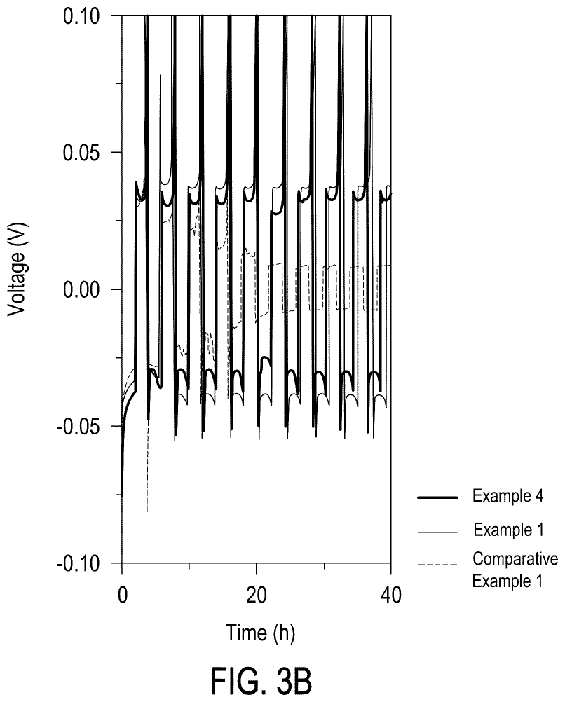

The current collectors of Example 1, Example 4, and Comparative Example 1 were respectively subjected to nucleation potential testing of half cells. The prepared current collectors were configured into half cells with lithium metal and electrolyte, wherein the structure of the half-cell was the electrolyte and lithium metal sequentially located on the alloy layer of the current collector, that was, the electrolyte was located between the lithium metal and the alloy layer of the current collector. The measurement conditions for the half-cells were 0.5 mA cm⁻² and 1 mAh cm⁻², that was, cycling was performed at 0.5 mA cm⁻² and-maintained for two hours. As can be known from FIG. 3A, compared to the half-cell composed of the current collector of Comparative Example 1, the half-cells composed of the current collector of Example 1 and Example 4 have lower nucleation potentials. Therefore, it can be known that compared to the half-cell of the current collector that does not include an alloy layer formed of alloy material with specific constituent elements and content (Comparative Example 1), the half-cells of the current collectors that include an alloy layer formed of alloy material with specific constituent elements and content (Examples 1 and 4) have lithium metal that nucleates more easily. Thereby, this may help suppress the formation of dendritic crystals in lithium batteries and improve the efficiency of charging and discharging of power storage devices. FIG. 3B is a curve diagram of potential varying with time during charging and discharging by configuring the current collectors of Example 1, Example 4, and Comparative Example 1 according to exemplary embodiments respectively into half-cell structures (wherein the measurement conditions are 0.5 mA cm⁻² and 1 mAh cm⁻²). As can be known from FIG. 3B, the half-cell of the current collector that does not include an alloy layer formed of alloy material with specific constituent elements and content (Comparative Example 1) shows short circuit after cyclic charging and discharging for about 5 cycles (less than 20 hours), while the half-cells of the current collector that include an alloy layer formed of alloy material with specific constituent elements and content (Examples 1 and 4) can stably cyclic charge and discharge for at least 40 hours. Therefore, it can be known that the half-cells of current collector that include an alloy layer formed of alloy material with specific constituent elements and content can stably perform charging and discharging.

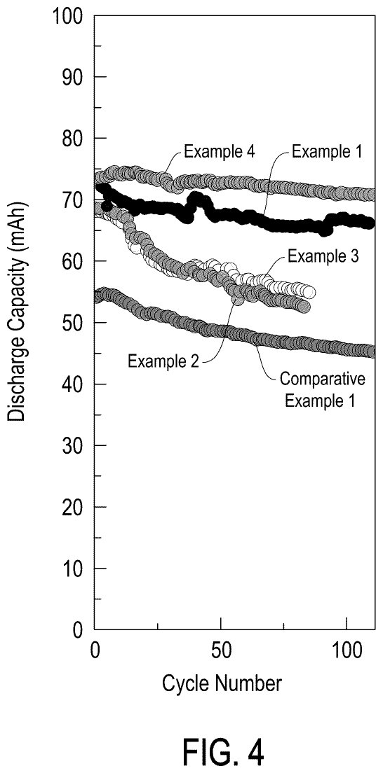

FIG. 4 is a curve diagram of discharge capacity varying with cycle number during cyclic charging and discharging of anode-free lithium batteries of Examples 1 to 4 and Comparative Example 1 according to exemplary embodiments (wherein the charging rate is 0.2C and the discharging rate is 1C). As can be known from FIG. 4, compared to the anode-free lithium battery with the current collector that does not include an alloy layer formed of alloy material with specific constituent elements and content (Comparative Example 1), the anode-free lithium batteries with the current collectors that include an alloy layer formed of alloy material with specific constituent elements and content (Examples 1 to 4) have increased discharge capacity (about 24%). Thereby, this may help improve the discharge capacity of power storage devices. In addition, the current collectors that include an alloy layer formed of alloy material with specific constituent elements and content have good reaction stability in anode-free lithium batteries. Thereby, power storage devices including the same may have good stability and discharge capacity.

Based on the above, when the current collector of the exemplary embodiments includes an alloy layer located on one side of the substrate, and the alloy material constituting the alloy layer includes specific constituent elements and content, the power storage device including the current collector has good suppression of dendrite formation in lithium batteries, improved discharge capacity, enhanced charging and discharging efficiency and stability, thereby improving the performance of the power storage device.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A current collector, comprising:
a substrate; and
an alloy layer located on one side of the substrate,
wherein a material of the alloy layer is an alloy material, the alloy material comprises aluminum, silicon and at least three other elements,
based on a sum of elements of the alloy material is 100 mole percentage, a sum of elements of aluminum and silicon is greater than or equal to 70 mole percentage.

2. The current collector as claimed in claim 1, wherein the other elements comprise vanadium, niobium, tungsten, copper, iron, cobalt, nickel or manganese.

3. The current collector as claimed in claim 1, wherein based on the sum of elements of the alloy material is 100 mole percentage, a content of aluminum is 40 mole percentage to 60 mole percentage.

4. The current collector as claimed in claim 1, wherein based on the sum of elements of the alloy material is 100 mole percentage, a content of silicon is 20 mole percentage to 30 mole percentage.

5. The current collector as claimed in claim 1, wherein a thickness of the alloy layer is 10 nanometers to 500 nanometers.

6. The current collector as claimed in claim 1, wherein a material of the substrate comprises copper, iron, tin, silicon or a combination thereof.

7. The current collector as claimed in claim 1, wherein a thickness of the substrate is 4 micrometers to 50 micrometers.

8. A power storage device, comprising the current collector as claimed in claim 1.

9. The power storage device as claimed in claim 8, further comprising:
a positive electrode; and
an electrolyte located between the positive electrode and the alloy layer.

10. The power storage device as claimed in claim 8, further comprising:
a positive electrode; and
a dielectric located between the positive electrode and the alloy layer.
